(19) United States
(12) Patent Application Publication
(10) Pub. No.: US 2005/0266156 A1
(43) Pub. Date: Dec. 1, 2005

(54) Method for joining lacquered wires in an electrically conducting manner

(76) Inventor: Anton Stapel, Goldbach (DE)

Correspondence Address: DENNISON, SCHULTZ, DOUGHERTY & MACDONALD, 1727 KING STREET, SUITE 105, ALEXANDRIA, VA, 22314, US

(21) Appl. No.: 10/518,380

(22) PCT Filed: Jun. 30, 2003
(86) PCT No.: PCT/EP03/06915

§ 371 Date: Mar. 29, 2005

(30) Foreign Application Priority Data
Jul. 1, 2002 (DE) 102 29 565.4

(51) Int. Cl. B05D 1/00

(52) U.S. Cl. 427/120; 427/8; 29/825

(57) ABSTRACT

A method for joining in an electrically conducting manner at least two wires that are provided with an insulating lacquer. In order to be able to interconnect several lacquered wires without using an electrically conducting joining piece therebetween and without having to remove the lacquer first, at least some of the areas of the lacquered wires which are to be joined, are enveloped by an electrically conducting material, and the wires are connected in a positive manner to the material by applying ultrasound while breaking up the insulating lacquer.

The invention relates to a method of connecting in an electrically conductive manner at least two wires provided with an insulating lacquer (lacquered wires).

In order to connect a lacquered wire with a conductor, it is known to weld them ultrasonically. In this way, a close connection is provided immediately between the wire and the conductor. It is also known to connect an end of a lacquered wire with a stranded wire.

In order to connect together two lacquered wires, without the lacquer coating having to be previously removed, it is known to firstly connect an end of the lacquered wire with a conductor, in order to then connect the conductor with the other end by means of ultrasonic welding. This type of connection is known e.g. from electric motors. In this way, and insulated armature winding is welded to a copper plate, from which further extends an insulated wire.

In order to connect several ends of lacquered wires in an electrically conductive manner, it is also known to insert these into a sleeve which has ridges extending from a surface, which on compression of the sleeve indent into the lacquering, which in turn breaks up. However, it is not ensured by these measures that wires which do not have immediate contact with the sleeve are in this way released in order to provide the desired electrically conductive connection with other wires.

From DE 19636217 A1, a method and a machine for welding lacquered wires are known. The lacquered wires are laid in a sonotrode or an anvil of an ultrasonic welding machine in order to be then welded.

The present invention is based on the problem of further developing a method of the first-mentioned type to so that a plurality of lacquered wires can be connected to one another without an electrically conductive connecting component having to extend between them and without the lacquer having to be firstly removed.

For solving this problem, it is basically proposed that the lacquered wires are at least partially enclosed, at regions in which they are to be connected, by an electrically conductive uninsulated material and that the wires are then positively connected to the material, with simultaneous breaking away of the insulating lacquer, by an ultrasound effect. It is thereby not absolutely necessary for the lacquered wires themselves to come into immediate contact with the electrically conductive material.

According to the invention, an ultrasonic welding machine applies ultrasound, in particular by means of work tools, onto the material surrounding the lacquered wires and forming a sleeve end, whereby a formation of the material is produced such that the material contacts the outer lacquered wires while simultaneously fixedly enclosing any other lacquered wires. Simultaneously, due to the ultrasonic effect, there is a relative movement between the lacquered wires and the sleeve end, with the result that the lacquer coating ruptures to an extent that, between the contacting lacquered wires, the lacquer coating is removed and consequently the desired electrically conductive connection occurs. This also holds true in the region of contact with the sleeve end. The removed insulating lacquer itself thereby passes into the intermediate space between the wires, so that the desired electric contact is not thereby negatively affected.

It is in particular foreseen that a plurality of the lacquered wires, with the stranded wire, are partially enclosed by the material in order to then obtain the fixed and conductive connection by the effect of ultrasound.

There is also the possibility, in a single work step, on one hand to connect the lacquered wires and/or stranded wire by the material at least partially enveloping them and, simultaneously, to connect the material itself by ultrasound to a carrier, such as e.g. copper plate, by means of ultrasonic welding.

Even if the material surrounding the lacquered wires is not necessarily inherently rigid—a copper mesh surrounding the lacquered wires can e.g. be used as the material—it is preferably provided that as the electrically conductive material, there is employed one in a sleeve or cup form. A solution such as this can be employed e.g. for a connection between an armature coil wire and a connection wire.

The electrically conductive material may be a sheet metal strip formed as a crimp. Also, a sheet or strip can be wound in single ply or multi-ply around the wires which are to be connected.

According to a further proposal, the lacquered wires and if required further conductors which are to be connected to them, are located in a preformed sheet metal, which in section has a U-shape, a circular section or an open trapezoidal shape, in order to then weld the formed sheet metal around the lacquered wires, and any conductor present, by means of an applied sonotrode or anvil and thus to produce a connection in accordance with the teaching of the invention.

As the lacquered wire, one can be employed which comprises aluminum or copper. The material surrounding the lacquered wires, which forms the sleeve end, should itself likewise or preferably comprise or contain copper.

Further details, advantages and features of the invention are given not only from the claims, and the features to be obtained therefrom—individually or in combination—but also from preferred embodiments to be obtained from the following description of the drawings, in which:

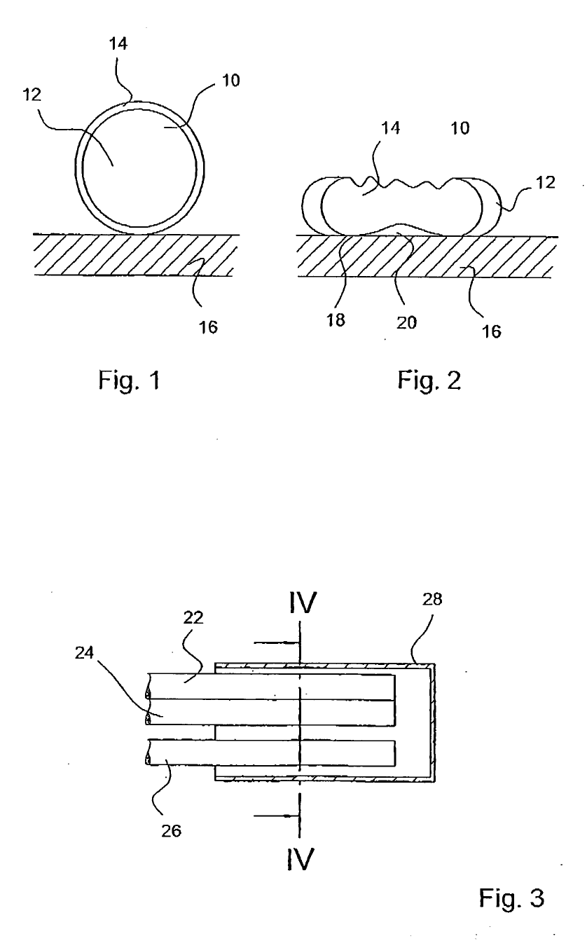

FIG. 1 show a lacquered wire which is to be connected to a carrier,

FIG. 2 shows a wire connected to the carrier in accordance with the state of the art,

FIG. 3 shows in longitudinal section a sleeve receiving a lacquered wire,

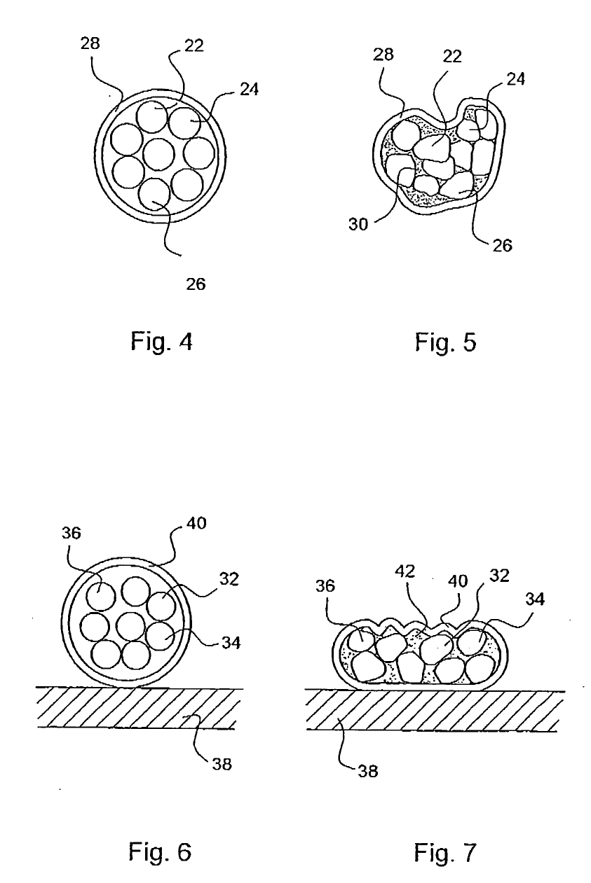

FIG. 4 shows a section along the line IV-IV of FIG. 3,

FIG. 5 shows, in the sleeve of FIGS. 3 and 4, the lacquered wires connected to one another and to the sleeve,

FIG. 6 shows a plurality of lacquered wires to be connected with a carrier,

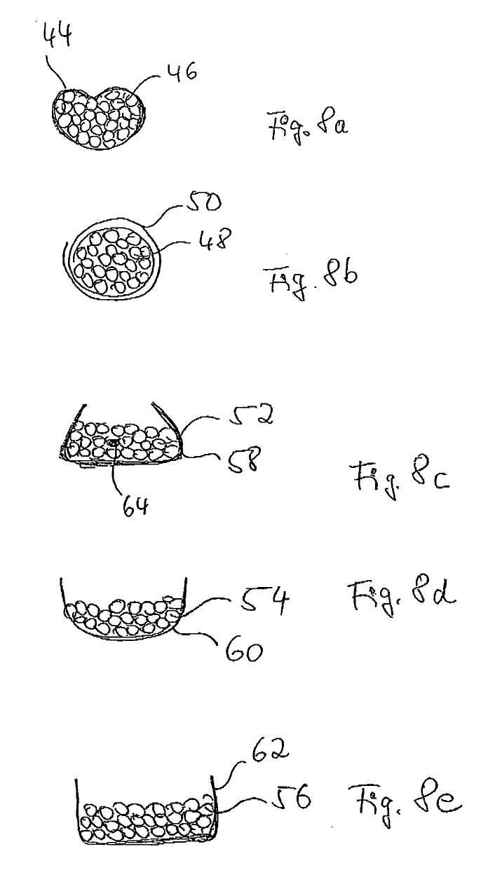

FIG. 7 shows the lacquered wires of FIG. 6 connected with the carrier and

FIGS. 8a-8e show the basic illustration of sleeve ends at least partially surrounding lacquered wires which are to be welded.

According to the state of the art, it is possible to connect a lacquered wire 10, comprising the core 12 of electrically conductive material such as copper or aluminum and outer lacquer coating 14, with an electrically conductive carrier 16. This is effected by means of ultrasonic welding. The wire 10 is deformed in accordance with the shape of the sonotrode and the application of ultrasound and the effect of pressure which occur, the lacquer coating 14 being separated in the area of contact between the carrier 16 and the lacquered wire 10 as a result of their movement relative to one another, and the desired contact 14 can thereby be obtained as the welding. Removed lacquer material is thereby deposited between the contact or weld positions indicated in FIG. 2 by reference numerals 18 and 20.

A corresponding type of connection is, however, not possible when a plurality of lacquered wires (lacquer wires), such as the ends thereof or a plurality of lacquered wires have to be connected to a carrier. In this case, it is either necessary to remove an insulating sleeve or to employ a connection carrier, in which firstly one end of a lacquered wire is connected to the carrier and then this is connected with the end of another lacquered wire, or else work tools (sonotrode, anvil) of an ultrasonic welding machine are geometrically formed so that the lacquer wires are fixed accurately in position.

According to the invention, it is now possible to connect a plurality of lacquered wires to one another in an electrically conductive manner by means of an ultrasonic welding machine. For this it is foreseen in accordance with FIGS. 3 to 8 that corresponding lacquered wires—in the embodiment, the ends 22, 24 26 thereof—are placed in a cup-shaped sleeve 28 of electrically conductive material such as copper. In the sleeve 28, the wires ends 22, 24, 26 are packed more or less tightly. Because of the lacquer coating, however, an electrically conductive connection exists neither between one another nor to the sleeve. According to the invention, the sleeve 28, with the wires 22, 24, 26, is placed between the work tools, i.e. the sonotrode and the counter electrode or anvil of an ultrasound welding machine, and ultrasound is then applied.

There is thereby produced a deformation of the sleeve 28 such that it fixedly encloses the wire ends 22, 24, 26. Simultaneously, as a result of the applied ultrasonic energy, there is a relative movement between both the sleeve 28 and the wire ends 22, 24, 26 and between the latter, so that the lacquering is ruptured at the points of contact, with the consequence that the desired electrically conductive connection is produced. By the fixed connection, the close contact is simultaneously ensured, whereby in addition a welding of the wire ends 22, 24 partially to one another and the sleeve 28 can occur.

Likewise, a plurality of lacquered wire ends 32, 34, 36 can also be connected simultaneously to one another and to a carrier 38, as shown in FIGS. 6 and 7. Thus, the wire ends 32, 34, 36 are placed in a sleeve 40, which is then arranged on the carrier 38, which in turn is arranged on a counterelectrode of an ultrasound welding machine. A sonotrode then acts on the sleeve 40, with the result that the sleeve deforms and the wire ends 32, 34, 36 are enclosed in a shape defining manner, a welding to the carrier occurring simultaneously. During this process, insulating lacquer present in the region of contact between the wire ends 32, 34, 36 or with the inner wall of the sleeve 40 is likewise removed and, which, in the finished product, accumulates in the intermediate space between the ends 32, 34, 36 and the inner wall of the sleeve 40 (see point 42).

While an inherently rigid element is disclosed in the embodiment, which receives the wire ends in the region of lacquered wires which are to be electrically conductively connected together, it is also possible, without further measures, to use a flexible material as the surrounding material. Thus, e.g. a copper mesh can be employed which, to the required extent, surrounds the lacquered wires which are to be connected, in order to be subsequently fixed by ultrasound, whereby a fixed connection with the lacquered wires in the above-described manner and a stripping thereof occur simultaneously. It is also notable that the material enabling the electrically conductive connection can surround the lacquered wires not only fixedly but also in an at least partially shape determining manner.

There is also a possibility to electrically conductively connect the lacquered wires not only to one another but also to e.g. stranded wires.

From FIGS. 8a to 8e, further embodiments to be emphasized can be seen, by which lacquered wires and any other electrical conductors present can be fixedly connected. Thus, in FIG. 8a, there is illustrated a sheet metal formed as a crimp 44 surrounding the conductors 46 to be connected together. In the embodiment of FIG. 8b, lacquer wires 48 are enveloped by a sheet metal material in single ply or multiple plies and then connected in accordance with the teaching according to the invention.

There is, however, also the possibility of placing lacquer wires 52, 54, 56 which are to be welded into preformed receptacles 58, 60, 62 which are open at one side, and which have a trapezoidal shape (FIG. 8c), a circular sectional shape (FIG. 8d) or a U-shape (FIG. 8e) in section. The lacquer wires 52, 54, 56 and any other conductor 64 to be welded are then placed in the forms 58, 60, 62 and subsequently fastened by the ultrasound welding process. In addition, the corresponding work tool of the ultrasound welding machine can have a geometry which enables closing or folding of the receptacles 58, 60, 62. By the ultrasound effect, the wires 52, 54, 56 are then fixedly enclosed by the receptacles 68, 62, the insulating lacquer of the wires 52, 54, 56 being simultaneously removed and the bared wires 52, 54, 56 then being welded to one another.

Typical dimensions of lacquered wires which are electrically conductively connected by the method according to the invention are those with inner diameters between 0.2 and 0.4 mm with a lacquer thickness between 0.1 and 0.2 mm, without the teaching according to the present invention being thereby limited.

1. A method for the electrically conductive connection of at least two wires provided with a insulating lacquer (lacquered wires), characterized in that the lacquered wires are at least partially enclosed, at their regions (22, 24, 26, 32, 36) which are to be connected, by an electrically conductive material, that by the ultrasound effect, on one hand, the insulating lacquer of the wires is broken away and, on the other hand, a fixed connection occurs between the electrically conductive material and the wires, with simultaneous electrically conductive connection between them.

2. A method according to claim 1, characterized in that a plurality of lacquered wires (46, 48, 52, 54, 56) and at least one uninsulated conductor (64), such as stranded wire, are partially enclosed by the material.

3. A method according claim 1, characterized in that as the electrically conductive material, one in the form of a sleeve or a cup is employed.

4. A method according to claim 1, characterized in that an inherently rigid material is employed as the electrically conductive material.

5. A method according to claim 1, characterized in that a flexible material, such as mesh, is employed as the electrically conductive material.

6. A method according to claim 1, characterized in that the material is connected in a shape defining manner with at least two, preferably more, lacquered wires.

7. A method according to claim 1, characterized in that the wires connected to the material and to one another in an at least shape defining manner are connected as a unit to an electrical conductor, such as a carrier (38), by means of ultrasound welding.

8. A method according to claim 1, characterized in that as the lacquered wire, one comprising a conductor of aluminum and/or copper is employed.

9. A method according to claim 1, characterized in that as the electrically conductive material, one of or containing copper is employed.

10. A method according to claim 1, characterized in that for applying the ultrasound, one or more work tools of an ultrasound welding machine are employed.

11. A method according to claim 1, characterized in that a sheet metal strip is employed as the electrically conductive material at least partially surrounding the lacquered wires (46, 48, 52, 54, 56) and any other conductor present.

12. A method according to claim 1, characterized in that a sheet metal strip formed as a crimp (44) is employed.

13. A method according to claim 1, characterized in that a single ply or multiple ply strip material is wound around the lacquered wires as the electrically conductive material.

14. A method according to claim 1, characterized in that as the electrically conductive material surrounding the lacquered wires and any further electrical conductor present, a preformed open receptacle (58, 60, 62), in particular with a U-, circularly or trapezoidally-shaped cross-section, is employed.
